(19) United States
(12) Patent Application Publication
(10) Pub. No.: US 2012/0016507 A1
(43) Pub. Date: Jan. 19, 2012

(54) PROCESSING SIMULATION METHOD AND APPARATUS, AND PROGRAM MAKING COMPUTER EXECUTE THE METHOD

(75) Inventors: Kenji Iriguchi, Tokyo (JP); Takashi Kamiya, Tokyo (JP); Mahito Matsuura, Tokyo (JP); Takashi Yoneda, Tokyo (JP); Nobuyuki Takahashi, Tokyo (JP)

(73) Assignee: MITSUBISHI ELECTRIC CORPORATION, Tokyo (JP)

(21) Appl. No.: 13/259,004

(22) PCT Filed: May 20, 2009
(86) PCT No.: PCT/JP2009/002212

§ 371 Date: Sep. 22, 2011

(51) Int. Cl. G05B 13/04

(52) U.S. Cl. 700/104

(57) ABSTRACT

A processing simulation method and apparatus is provided, which can appropriately detect interference between a tool processing area and a shape model of a material without being affected by the accuracy of expression of a tool movement path and the shape model. A tool shape model for processing a material, that includes a strict tool shape, and a tool shape model for checking interference, that is included in the strict tool shape, are generated by tool model setting unit according to an error range set in consideration of the tool movement path and the expression accuracy of the shape model, and the processed material shape model is generated by generating a tool processing area shape model from the tool movement path during processing feed and the tool shape model for processing the material and removing the tool processing area shape model from the material shape model. The tool processing area shape model is generated from a tool movement path during fast feed and the tool shape model for detecting the interference, and the interference between the tool processing area shape model and the material shape model is detected.

### TECHNICAL FIELD

The present invention relates to a processing simulation method and apparatus which can generate a shape model of a processed material from a shape model of the material, a shape model of a tool, and a shape model of a tool processing area that is defined from a tool movement path, and more particularly to a processing simulation method and apparatus which can prevent an excessive detection of interference between a tool and a material on a tool movement path during fast feed of the tool.

### BACKGROUND ART

In the related art, as a processing simulation apparatus that generates and displays a shape model of a processed material based on shape models of a material and a tool and tool movement path information, an apparatus is known, which can generate and display a shape model of a processed material by generating a shape model of a tool processing area, which is an area that can be processed when the tool moves on a tool movement path, in a sweep process of a tool shape model according to the tool movement path and removing the shape model of the generated tool processing area from a shape model of the material through a set operation.

Further, in the case where the tool movement path corresponds to fast feed that is not for the purpose of processing, an apparatus is known, which detects interference between the shape model of the generated tool processing area and the shape model of the material (see Patent Citation 1).
[Patent Citation 1] JP-A-2000-284819

### DISCLOSURE OF INVENTION

### Technical Problem

The above-described processing simulation apparatus has the problems that in the case of a tool movement path for fast feed, in which a tool is in a contact state with a processed surface of the processed material, it is unable to obtain a stable result of the interference detection in detecting interference between the tool processing area and the shape model of the material, and the interference is excessively detected. This is because it is difficult to appropriately recognize whether the tool processing area and the shape model of the material “are in contact with each other” or “cross each other” in interference detection operation in the case where the tool processing area and the shape model of the material minutely cross each other due to the influence of the accuracy of expression of the tool movement path and the shape model.

The present invention addresses the above-described problems involved in the related art, and provides a processing simulation method and apparatus which can stably and accurately detect interference between a tool processing area and a shape model of a material without being affected by the accuracy of expression of a tool movement path and the shape model.

### Technical Solution

According to the present invention, there provided a processing simulation method for generating a shape model of a processed material from a material shape model, a tool shape model, and a tool processing area shape model defined from a tool movement path, which includes generating a tool shape model for processing a material, that includes a strict tool shape, and a tool shape model for detecting interference, that is included in the strict tool shape; generating the processed material shape model by generating a tool processing area shape model based on a tool movement path during processing feed and the tool shape model for processing the material and removing the tool processing area shape model from the material shape model; and generating the tool processing area shape model based on a tool movement path during fast feed and the tool shape model for detecting the interference, and detecting the interference between the tool processing area shape model and the material shape model.

In the processing simulation method according to the present invention, in the case of generating the tool shape model for processing the material, that includes the strict tool shape, and the tool shape model for detecting the interference, that is included in the strict tool shape as the tool shape models, error ranges are set from the strict tool shapes of the tool shape models for processing the material and for detecting the interference, respectively, based on set values of predetermined simulation accuracies, and the tool shape models for processing the material and for detecting the interference are generated based on the set error ranges.

According to the present invention, there is provided a processing simulation apparatus for generating a shape model of a processed material from a material shape model, a tool shape model, and a tool processing area shape model defined from a tool movement path, which includes tool shape model setting unit for generating a tool shape model for processing a material, that includes a strict tool shape, and a tool shape model for detecting interference, that is included in the strict tool shape; processed material model generation unit for generating the processed material shape model by generating a tool processing area shape model based on a tool movement path during processing feed and the tool shape model for processing the material and removing the tool processing area shape model from the material shape model; and tool interference detection unit for generating the tool processing area shape model based on a tool movement path during fast feed and the tool shape model for detecting the interference, and detecting the interference between the tool processing area shape model and the material shape model.

In the processing simulation apparatus according to the present invention, the tool shape model setting unit includes a setting unit for setting error ranges from the strict tool shapes of the tool shape models for processing the material and for detecting the interference, respectively, based on set values of predetermined simulation accuracies; and a generation unit for generating the tool shape models for processing the material and for detecting the interference based on the set error ranges.

### ADVANTAGEOUS EFFECTS

According to the present invention, since a processed surface of the material shape model can be formed in a position that is spaced apart for equal to or more than a predetermined amount from the tool processing area formed in the strict tool shape and during the interference checking, the interference detection is performed between the material shape model and the tool processing area that is inwardly spaced apart for equal to or more than the predetermined amount from the tool processing area formed in the strict tool shape, a gap of equal to or more than the predetermined amount is formed between the tool processing area and the processed surface of the material in the fast feed tool movement path in which the tool processing area and the processed surface of the material are in contact with each other in the case of using the strict tool shape, and thus it is not required to determine whether the models “are in contact with each other” in detecting the interference to obtain the stable and accurate result of the interference detection.

### BRIEF DESCRIPTION OF DRAWINGS

FIG. 1 is a block diagram illustrating the configuration of a processing simulation apparatus according to embodiment 1 of the present invention.

FIG. 2 is a flowchart illustrating an operation of the processing simulation apparatus according to embodiment 1 of the invention.

FIG. 3 is a view illustrating an operation of a material shape model setting unit of the processing simulation apparatus according to embodiment of the invention.

FIG. 4 is a view illustrating an operation of a tool shape model setting unit of the processing simulation apparatus according to embodiment 1 of the invention.

FIG. 5 is a view illustrating an operation of a processed material generation unit of the processing simulation apparatus according to embodiment of the invention.

FIG. 6 is a view illustrating an operation of a processed material generation unit of the processing simulation apparatus according to embodiment 1 of the invention.

FIG. 7 is a view illustrating an operation of a tool interference detection unit of the processing simulation apparatus according to embodiment of the invention.

FIG. 8 is a view illustrating an operation of a tool interference detection unit of the processing simulation apparatus according to embodiment 1 of the invention.

### EXPLANATION OF REFERENCE

1: MATERIAL SHAPE MODEL SETTING UNIT
2: SIMULATION EXECUTION UNIT
3: TOOL SHAPE MODEL SETTING UNIT
4: PROCESSED MATERIAL GENERATION UNIT
5: TOOL INTERFERENCE DETECTION UNIT
6: PROCESSED MATERIAL/INTERFERENCE INFORMATION DISPLAY UNIT
7: MATERIAL SHAPE DEFINITION INFORMATION STORAGE UNIT
8: MATERIAL SHAPE MODEL STORAGE UNIT
9: NC PROGRAM STORAGE UNIT
10: PROCESSING FEED TOOL MOVEMENT PATH STORAGE UNIT
11: FAST FEED TOOL MOVEMENT PATH STORAGE UNIT
12: SIMULATION ACCURACY INFORMATION STORAGE UNIT
13: STRICT TOOL SHAPE INFORMATION STORAGE UNIT
14: TOOL SHAPE MODEL STORAGE UNIT FOR PROCESSING A MATERIAL
15: TOOL SHAPE MODEL STORAGE UNIT FOR DETECTING INTERFERENCE
16: INTERFERENCE INFORMATION STORAGE UNIT

### BEST MODE FOR CARRYING OUT THE INVENTION

### Embodiment 1

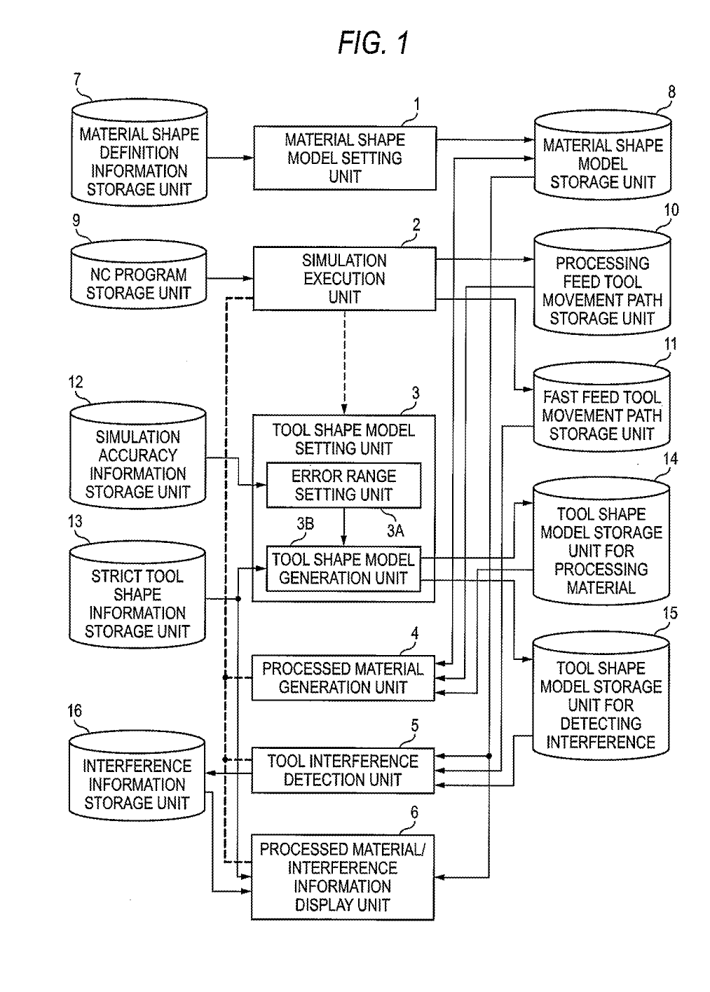

Hereinafter, embodiment 1 of the invention will be described using FIGS. 1 to 8.

FIG. 1 is a block diagram illustrating the configuration of a processing simulation apparatus according to embodiment 1 of the present invention, which displays a state where work is processed by a tool that is moved by an NC processing program, the situation of interference between the tool and the work, and the like, on a display. In this case, this simulation apparatus may be assembled onto a numerical control device or may be constructed on a personal computer. Further, software that configures the processing simulation apparatus may be circulated in a state where it is stored in a recording medium or may be installed on the numerical control device or the personal computer to be used.

In FIG. 1, a material shape model setting unit generates a material shape model before being processed from material shape definition information that is stored in a material shape definition information storage unit 7, and stores the generated material shape model in a material shape model storage unit 8.

A simulation execution unit 2 analyzes an NC program stored in an NC program storage unit 9, and stores tool movement path data during processing feed, that is obtained from the NC program in a processing feed tool movement path storage unit 10. Also, the simulation execution unit 2 stores tool movement path data during fast feed, that is obtained from the NC program in a fast feed tool movement path storage unit 11, and commands execution of processes of respective units, such as the toll shape model setting unit 3, a processed material generation unit 4, a tool interference detection unit 5, and a processed material/interference information display unit 6.

A tool shape model setting unit 3 sets an error range from a strict tool shape of a tool shape model for processing a material and an error range from a strict tool shape of a tool shape model for detecting interference based on accuracy information stored in a simulation accuracy information storage unit 12 according to an execution command from the simulation execution unit 2. Further, the tool shape model setting unit 3 generates the tool shape model for processing the material and the tool shape model for detecting the interference from the set error ranges and strict tool shape information stored in a strict tool shape information storage unit 13, and stores the generated tool shape model for processing the material and the tool shape model for detecting the interference in a tool shape model storage unit 14 for processing the material and a tool shape model storage unit 15 for detecting the interference, respectively.

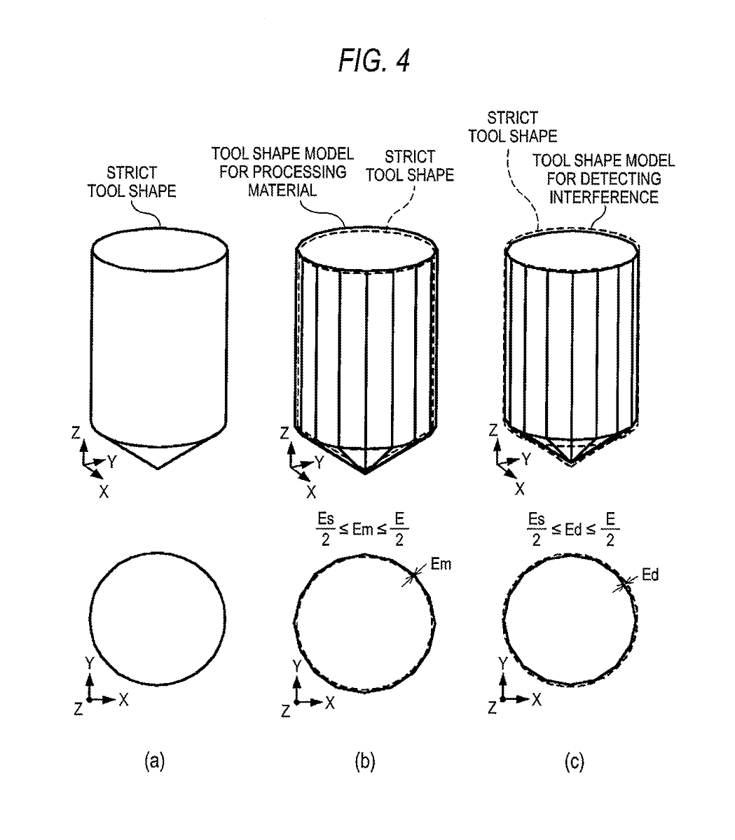

In this case, the strict tool shape indicates the shape of an ideal tool (see FIG. 4(a)) that is set forth as a premise since an NC processing program is prepared on the assumption that the ideal tool is processed so that a processing path (an ideal processing path) commanded by the NC processing program is obtained. Further, the reason why the wording “the strict tool shape” is used and the wording “a strict tool shape model” is not used is that the strict tool shape model is not generated but only the strict tool shape data is processed.

Further, the tool shape model for processing the material, as illustrated in FIG. 4(b), indicates a tool shape model that is generated to include the strict tool shape, and the tool shape model for detecting the interference, as illustrated in FIG. 4(c), indicates a tool shape model that is generated to be included in the strict tool shape.

The processed material generation unit 4 generates a material shape model after processing by generating a tool processing area shape model from the tool movement path data during the processing feed, that is stored in the processing feed tool movement path storage unit 10 and the tool shape model for processing the material, that is stored in the tool shape model storage unit 14 for processing the material according to the execution command from the simulation execution unit 2, and removing the generated tool processing area shape model from the material shape model stored in the material shape model storage unit 8 through a set operation, and stores the generated material shape model after processing in the material shape model storage unit 8.

The tool interference detection unit 5 generates a tool processing area shape model from the tool movement path data during fast feed, that is stored in the fast feed tool movement path storage unit 11 and the tool shape model for detecting the interference, that is stored in the tool shape model storage unit 15 for detecting the interference according to the execution command from the simulation execution unit 2, detects interference between the generated tool processing area shape model and the material shape model stored in the material shape model storage unit 8, and stores interference information (block information or the like inside the NC program for the tool movement path during the interference) in the interference information storage unit 16 in the case where the interference is detected.

The processed material/interference information display unit 6 generates a shadow image of the material shape model stored in the material shape model storage unit 8 according to the execution command from the simulation execution unit 2, and updates the shadow image on the display with the generated shadow image. Further, if the interference information is present in the interference information storage unit 16, the processed material/interference information display unit 6 displays the contents of the interference information on the display.

In this case, the material shape model setting unit 1, the simulation execution unit 2, the tool shape model setting unit 3, the processed material generation unit 4, the tool interference detection unit 5, and the processed material/interference information display unit 6 are mainly configured by software.

Further, the hardware configuration of the simulation apparatus is a general configuration composed of a CPU, a memory, and the like.

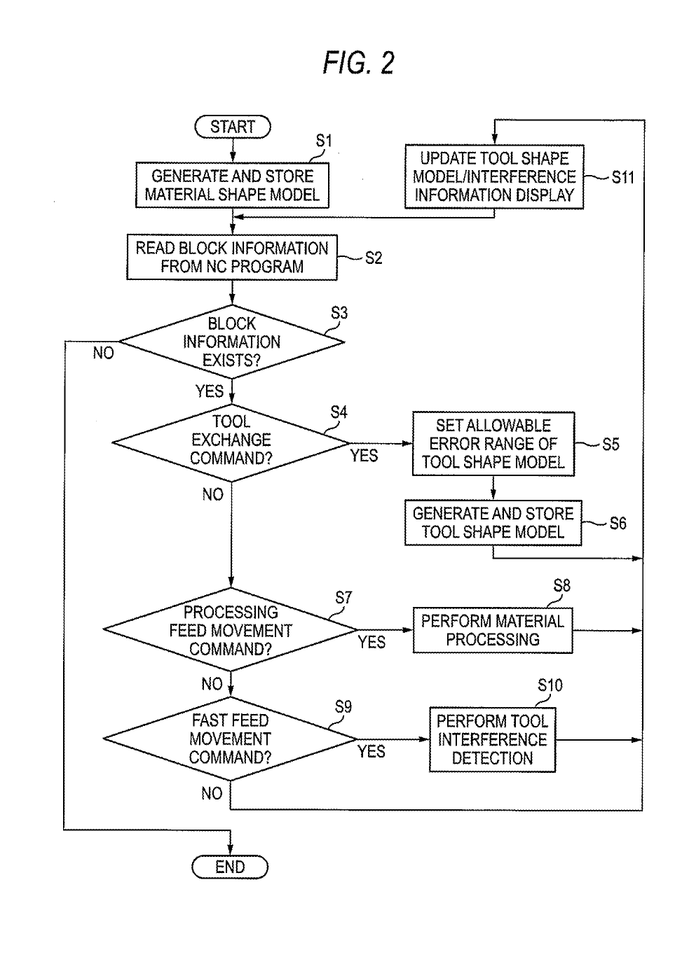

The processing simulation apparatus as configured above operates according to the flowchart illustrated in FIG. 2.

In step S1, the material shape model setting unit generates the material shape model before processing from the material shape definition information stored in the material shape definition information storage unit 7, and stores the generated material shape model in the material shape model storage unit 8.

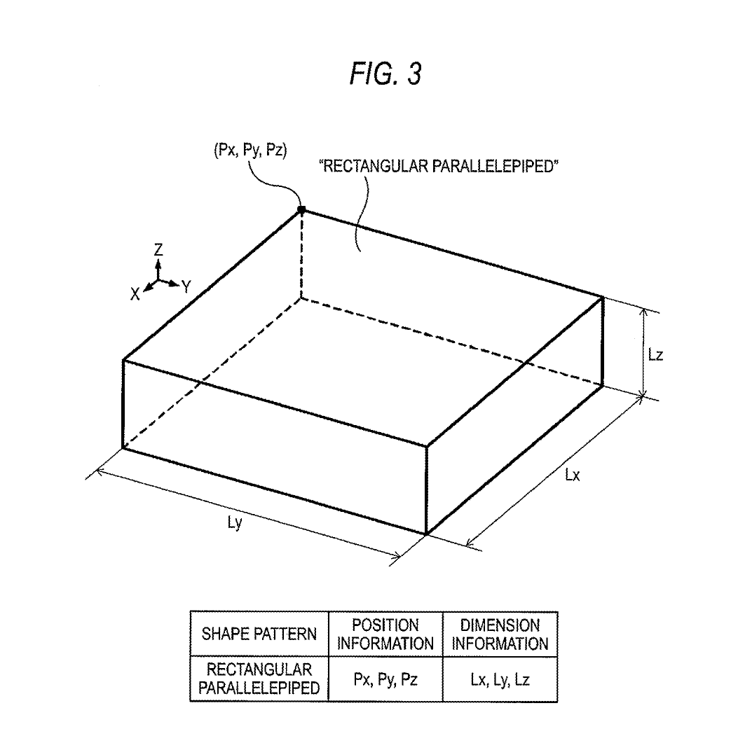

FIG. 3 illustrates an example in the case where a rectangular parallelepiped material shape model generated. Here, the material shape definition information includes the pattern of the shape (rectangular parallelepiped), the position (Px, Py, Pz), and dimensions (Lx, Ly, Lz).

In step S2, the simulation execution unit 2 reads the block information that configures the NC program from the NC program. The block information may be a command (T command) for tool exchange, commands (GO1, GO2, and GO3 commands) for tool movement during processing, a command (GO0 command) for tool movement during fast feed, and the like.

In step S3, the simulation execution unit 2 checks whether the block information that is read from the NC program exists, and terminates the operation if the block information does not exist, while it proceeds to step S4 if the block information exists.

In step S4, the simulation execution unit 2 checks whether the read block information is a command for tool exchange, and proceeds to step S5 if the block information is the command (T command) for tool exchange, while it proceeds to step S7 if the block information is not the command for the tool exchange.

In steps S5 and S6, the tool shape model setting unit 3 reads the tool information stored in the strict tool shape information storage unit 13, which corresponds to a tool number, based on the tool number designated in the block information for the tool exchange, and generates a tool shape model for processing the material (a tool shape model that is generated to include the strict tool shape) and a tool shape model for detecting the interference (a tool shape model that is generated to include the strict tool shape) as tool shape models for the tool numbers designated in the tool exchange block information.

In step S5, an error range setting unit 3A of the tool shape model setting unit 3 sets the respective error ranges for the strict tool shapes of the tool shape model for processing the material (the tool shape model that is generated to include the strict tool shape) and the tool shape model for detecting the interference (the tool shape model that is generated to include the strict tool shape) based on the accuracy information that is stored in the simulation accuracy information storage unit 12.

The error ranges are determined, for example, as follows.

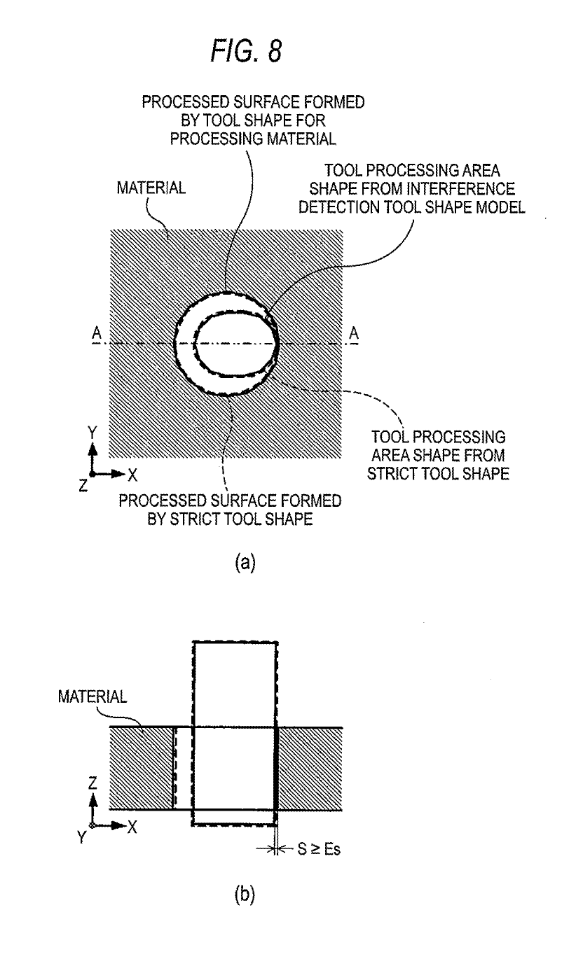

That is, in the case where a material processed surface and a tool processing area shape are in contact with each other in the strict tool shape, for example, as illustrated in FIG. 8, in the case where the processed surface by the strict tool shape and the tool processing area shape from the strict tool shape are in contact with each other, if it is assumed that a distance that is at least to be secured between the processed surface by the tool shape model for processing the material and the tool processing area shape by the tool shape model for detecting the interference is Es (>0), accuracy of a predetermined simulation is E (>Es), the amount of error between the tool shape model for processing the material and the strict tool shape is Em, and the amount of error between the tool shape model for detecting the interference and the strict tool shape is Ed, their error ranges are set as follows.

Es/2≦Em≦E/2

Es/2≦Ed≦E/2

In this case, Es is set by a user or set in advance in the simulation apparatus, and E is set by the user.

In step S6, a tool shape model generation unit 3B of the tool shape model setting unit 3 generates the tool shape model for processing the material and the tool shape model for detecting the interference so that the errors are gathered within the error ranges determined as above, and stores the tool shape model for processing the material in the tool shape model storage unit 14 for processing the material and stores the tool shape model for detecting the interference in the tool shape model storage unit 15 for detecting the interference.

FIG. 4 shows an example in the case where a polyhedron-approximate tool shape model is set as a set tool shape model, in which, FIG. 4(a) shows a strict tool shape that is the basis of the tool shape model to be generated, FIG. 4(b) shows an example of a tool shape model for processing the material (a tool shape model that is generated to include the strict tool shape), and FIG. 4(c) shows an example of a tool shape model for detecting the interference (a tool shape model that is generated to be included in the strict tool shape).

After step S6, the processing proceeds to step S11.

In step S7, the simulation execution unit 2 checks whether the read block information is the tool movement command during the processing feed, and if so, the simulation execution unit 2 proceeds to step S8, while otherwise, it proceeds to step S9.

In step S8, the processed material generation unit 4 updates the material shape model with that after the processing by generating the tool processing area shape model from the tool movement path during the processing feed (during GO1, GO2, and GO3 commands) stored in the processing feed tool movement path storage unit 10 and the tool shape model for processing the material, that is generated in step S6, and removing the generated tool processing area shape model from the material shape model that is stored in the material shape model storage unit 8 through a set operation.

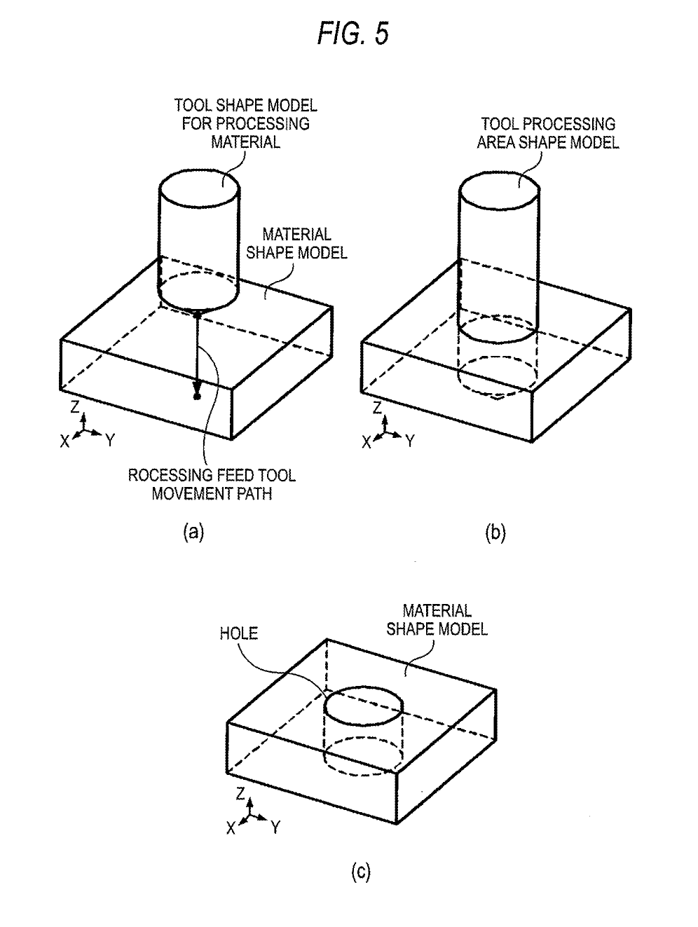

FIG. 5 shows a processing example in step S8 of FIG. 2, in which FIG. 5(a) shows the relationship between a material shape model before processing, a tool shape model for processing the material, and a tool movement path during processing feed, FIG. 5(b) shows a state where a tool processing area shape model is generated from a tool shape model and a tool movement path, and FIG. 5(c) shows a material shape model that is updated through removal of a generated tool processing area shape model by a set operation.

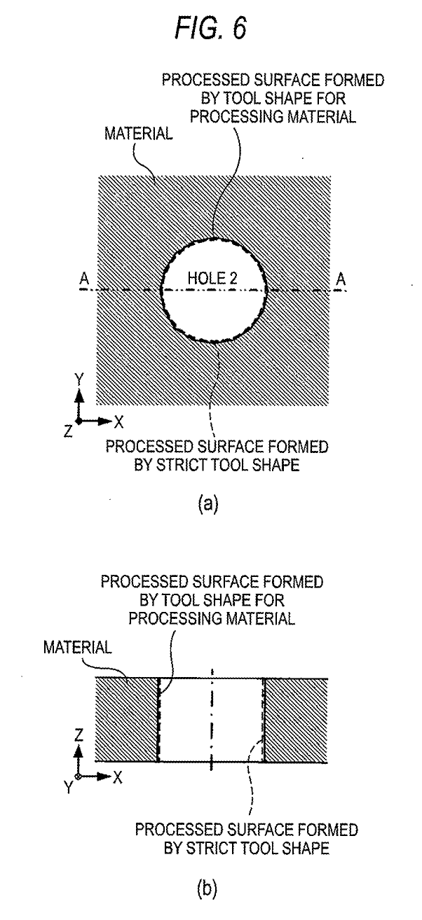

FIG. 6 shows a processed surface of a material shape model that is updated using a tool shape model for processing the material illustrated in FIG. 4. Since the tool shape model for processing the material includes the strict tool shape, the processed surface that is formed on the material shape model is widened outward at least as long as Es/2 or more with respect to that formed by the strict tool shape. In this case, FIG. 6(a) is a plan view, and FIG. 6(b) is a cross-sectional view taken along line A-A of FIG. 6(a).

After step S8, the processing proceeds to step S11.

In step S9, the simulation execution unit 2 checks whether the read block information is the tool movement command during the fast feed, and if so, the simulation execution unit 2 proceeds to step S10, while otherwise, it proceeds to step S2.

In step S10, the tool interference detection unit 5 generates the tool processing area shape model from the tool movement path during the fast feed (during GO0 command), that is stored in the fast feed tool movement path storage unit 11 and the tool shape model for detecting the interference, that is generated in step S6, detects interference between the generated tool processing area shape model and the material shape model, and stores the position of the block information in which the interference has occurred in the NC program as the interference information in the case where the interference is detected.

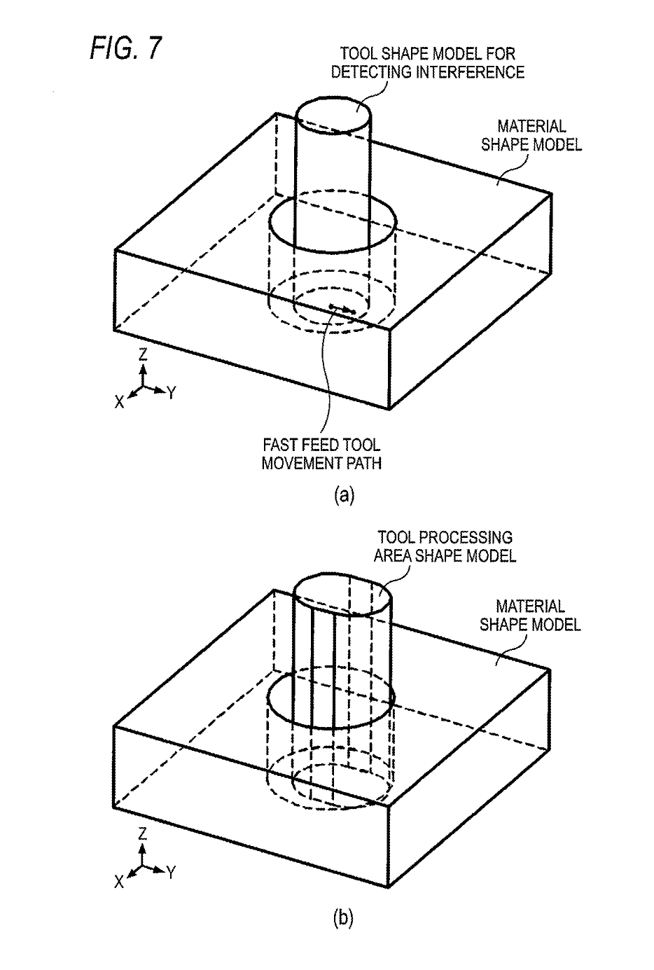

FIG. 7 shows a processing example in step S10 of FIG. 2. FIG. 7(a) shows the relationship between a material shape model before processing, a tool shape model for detecting the interference, and a tool movement path during fast feed. As the tool movement path, in the strict tool shape, the tool which has entered into a hole unit of the material moves up to the position where the tool becomes in contact with the processed surface of the hole unit. FIG. 7(b) shows shapes of a tool shape model in which the interference detection operation is performed, a tool processing area shape model that is generated from the tool movement path, and a material shape model. FIG. 7 shows an example in the case where hole processing is performed with respect to the material, and then the side surface of the hole is finish-processed.

FIG. 8 shows the relationship between the tool processing area shape model during the interference detection operation and the processed surface of the material shape model, in which FIG. 8(a) is a front view, and FIG. 8(b) is a cross-sectional view taken along line A-A of FIG. 8(a). In FIG. 8, the tool shape model for detecting the interference is included in the strict tool shape, and the tool processing area shape is inwardly spaced apart at least as long as Es/2 or more with respect to that formed by the strict tool shape. Since the processed surface of the material shape is outwardly widened at least as long as Es/2 or more with respect to that formed by the strict tool shape, a gap at least as long as Es or more is secured between the tool processing area shape and the processed surface of the material shape. Accordingly, it becomes unnecessary to recognize the contact state between models in the interference detection operation to be stable and free from intervention, and thus excessive interference detection can be prevented.

In step S11, the processed material/interference information display unit 6 generates a shadow image of the material shape model, and updates the shadow image on the display with the generated shadow image. Further, if the stored interference information is present, the processed material/interference information display unit 6 displays the contents of the interference information on the display.

After the step S11, the processing returns to the step S2 to read the next block information of the NC program.

The operation of the processing simulation apparatus according to the present invention is as described above.

According to embodiment 1 of the invention, in the simulation in a state where the tool that moves on the tool movement path through fast feed is in contact with the processed surface of the material shape, a gap of a specified amount or more is secured between the tool processing area shape and the processed surface of the material shape. Accordingly, it becomes unnecessary to recognize the contact state between models in the interference detection between the tool processing area shape and the material shape to be stable and free from intervention, and thus unnecessary interference detection can be prevented.

### INDUSTRIAL APPLICABILITY

The processing simulation apparatus according to the present invention is a processing simulation apparatus for performing verification of the NC program that is provided in a numerical control device, and is suitable to be used as a processing simulation apparatus for predicting and preventing the interference between the processed material and the tool during the operation of a machine tool.

1. A processing simulation method for generating a shape model of a processed material from a material shape model, a tool shape model, and a tool processing area shape model defined from a tool movement path, comprising:
generating a tool shape model for processing a material, that includes a strict tool shape, and a tool shape model for detecting interference, that is included in the strict tool shape;
generating the processed material shape model by generating a tool processing area shape model based on a tool movement path during processing feed and the tool shape model for processing the material and removing the tool processing area shape model from the material shape model; and
generating the tool processing area shape model based on a tool movement path during fast feed and the tool shape model for detecting the interference, and detecting the interference between the tool processing area shape model and the material shape model.

2. The processing simulation method according to claim 1,
wherein in the case of generating the tool shape model for processing the material, that includes the strict tool shape, and the tool shape model for detecting the interference, that is included in the strict tool shape as the tool shape models, error ranges are set from the strict tool shapes of the tool shape models for processing the material and for detecting the interference, respectively, based on set values of predetermined simulation accuracies, and the tool shape models for processing the material and for detecting the interference are generated based on the set error ranges.

3. A program for making a computer execute a method described in claim 1.

4. A processing simulation apparatus for generating a shape model of a processed material from a material shape model, a tool shape model, and a tool processing area shape model defined from a tool movement path, comprising:
a tool shape model setting unit for generating a tool shape model for processing a material, that includes a strict tool shape, and a tool shape model for detecting interference, that is included in the strict tool shape;
a processed material model generation unit for generating the processed material shape model by generating a tool processing area shape model based on a tool movement path during processing feed and the tool shape model for processing the material and removing the tool processing area shape model from the material shape model; and
a tool interference detection unit for generating the tool processing area shape model based on a tool movement path during fast feed and the tool shape model for detecting the interference, and detecting the interference between the tool processing area shape model and the material shape model.

5. The processing simulation apparatus according to claim 4,
wherein the tool shape model setting unit comprises:
a setting unit for setting error ranges from the strict tool shapes of the tool shape models for processing the material and for detecting the interference, respectively, based on set values of predetermined simulation accuracies; and
a generation unit for generating the tool shape models for processing the material and for detecting the interference based on the set error ranges.
